(19) United States
(12) Patent Application Publication
(10) Pub. No.: US 2014/0255576 A1
(43) Pub. Date: Sep. 11, 2014

(54) METHOD OF OPERATING A COMMERICAL COOKING DEVICE AS WELL AS COMMERCIAL COOKING DEVICE, IN PARTICULAR COMBI STEAMER

(71) Applicants: Hannes Wild, Riegsee (DE); Martin Nitzsche, Peissenberg (DE)

(72) Inventors: Hannes Wild, Riegsee (DE); Martin Nitzsche, Peissenberg (DE)

(73) Assignee: CONVOTHERM-ELEKTROGERÄTE, Eglfing (DE)

(21) Appl. No.: 14/234,528

(22) PCT Filed: Aug. 10, 2011
(86) PCT No.: PCT/EP2011/004008

§ 371 Date: May 23, 2014

(51) Int. Cl. A47J 27/04; A23L 1/01

(52) U.S. Cl. CPC A47J 27/04; A23L 1/0121; A47J 2027/043
USPC 426/510; 99/330; 426/523

(57) ABSTRACT

A method of operating a commercial cooking device with the following method steps: loading food products into a cooking chamber of the cooking device; starting an associated cooking program including starting to run a motor of a fan for circulating hot air and/or steam within the cooking chamber for the purpose of cooking the food products; and stopping the motor of the fan at a predetermined period of time before the associated cooking program is finalized.

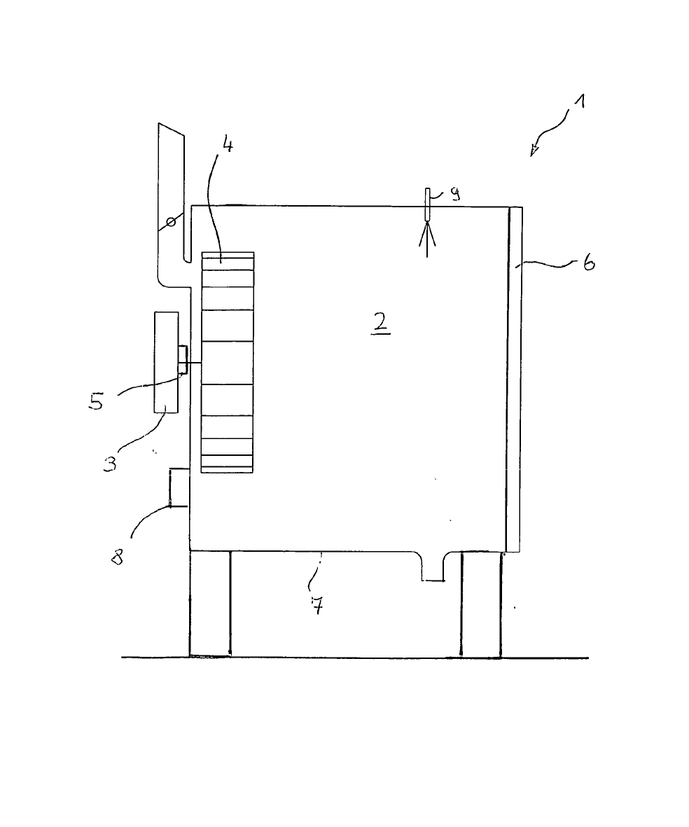

The present invention concerns a method of operating a commercial cooking device according to claim 1 as well as a commercial cooking device, in particular a combi steamer, according to the preamble part of claim 6.

A commercial cooking device comprises a cooking chamber that can be opened and closed by a door. After a cooking process during which a cooking program for the food products to be cooked is performed, is finished the door of the cooking chamber is immediately opened. The door opening process triggers a sensor (e.g. a read switch, a microprocessor or so on) and the motor of the fan for circulating hot air and/or steam within the cooking chamber will be stopped either directly or via the control means of the cooking device. The inertia of the fan wheel, however, results in the problem that the fan wheel will still run for a certain period of time until a standstill while the door is already open. Consequently, a high cooking chamber temperature drop, a high steam-, smoke- and/or odour-escape will take place having the negative effects of a risk of scalding, a higher impact to the kitchen exhaust system and a wider spread of grease what results in a contamination of kitchen components and can make the kitchen floor slippery. Moreover, because of the high and quick temperature drop, food that is still located in the cooking chamber may not reach the correct core temperature what may be a food safety issue.

It is, therefore, an object of the present invention to provide a method of operating a commercial cooking device as well as a commercial cooking device, in particular a combi steamer, that are able to overcome the before-explained drawbacks of the prior art.

The solution of this object is achieved by the features of claims 1 and 5, respectively.

According to the principles of the present invention, the motor of the cooking chamber driving the fan will be stopped before the cooking program for the food products that are loaded in the cooking chamber is finalized. So, the motor and the fan the motor is driving are fully stopped when the door of the cooking chamber is opened.

So, as a main aspect, the method and commercial cooking device according to the present invention result in the advantage that the climate within the cooking chamber is not remarkably influenced when the door is opened as at this point of time the fan has reached a standstill so that it cannot blow hot air and/or steam out of the cooking chamber. This, of course, also results in a reduced cooking temperature drop and a safe and correct termination of the cooking mode for the associated food products that are loaded into the cooking chamber. This aspect is especially important for a so-called rolling loading and unloading of food products what means that a plurality of products that are loaded into the cooking chamber and that can be cooked with the same cooking program have to be unloaded at different points of time as the respective cooking period may be different.

The further advantage that can be achieved with the principles of the present invention is a reduction of a risk of scalding and a minimization of the steam load in the kitchen in which the commercial cooking device is located.

In other words, before the cooking program is finished, the motor of the fan of the cooking chamber will be stopped usually a couple of seconds before the predetermined cooking time of the respective cooking program is elapsed.

If the respective cooking program is based on a core temperature mode, the motor will be stopped at a point of time that corresponds to a predetermined amount of degrees before reaching the target core temperature.

Although, for the purpose of reducing the danger of scalding, EP 0 937 400 B1 suggests a removal of dampness prior to the termination of the baking or cooking process, this necessitates the operation of the motor and the fan as otherwise the removal of dampness would not be possible.

The dependent claims contain advantageous embodiments of the method according to the present invention.

So, the motor can be stopped by either actuating a motor brake or by interrupting the electric power supply to the motor.

Moreover, after the cooking time is elapsed or the desired core temperature is reached, and if after a certain period of time the door of the cooking chamber is not opened, the motor of the fan and the heating elements of the cooking chamber can be reactivated.

The predetermined period of time at which the motor is stopped can be adjusted according to different parameters, as e.g. the product load of the cooking chamber, the cooking mode or cooking program and/or the cooking temperature as well as the core temperature.

Further details, advantages and features of the present invention will become apparent from the following description of the single FIGURE of the drawings.

This FIGURE shows a commercial cooking device 1 in a highly simplified way although, of course, the cooking device comprises all usual components and functions of such cooking devices that, however, are not necessary in order to describe the principles of the present invention.

Cooking device 1 comprises a cooking chamber 2 that is located in a housing 7. The cooking chamber 2 of the housing 7 can be opened and closed by means of a door 6 in order to load and unload food products into and out of the cooking chamber 2.

The FIGURE shows, moreover, a fan 4 located within the cooking chamber 2. Fan 4 is driven by a motor 3 that, according to the preferred embodiment of the FIGURE, can be equipped with a motor brake 5. Finally the cooking device 1 comprises a control means 8 that is adapted to control all the components of the cooking device, especially the motor 3, its brake 5 (if provided), heating means (not shown) as well as a cleaning device that is represented by a nozzle 9.

According to the principles of the present invention, the method of operating said commercial cooking product 1 provides, as a first step, loading food products which can be of any kind into the cooking chamber 2 of the cooking device 1.

Thereafter, the associated cooking program or cooking mode with which the respective food products loaded in the cooking chamber 2 can be cooked is started. This start of the cooking product means that the motor 3 starts to run and that the fan within the cooking chamber 2 is driven. Of course, this start of the cooking program also means that the heating means and other components are operated enabling the performance of the respective cooking program.

The control means 8 controlling all these components and functions will, according to the principles of the present invention, stop the motor 3 at a predetermined period of time before the associated cooking program is finalized. This means, in other words, that the motor 3 and the fan 4 will be stopped first, and, thereafter, the cooking program will be finalized at a later point of time so that it is ensured that the motor 3 as well as the fan 4 have reached a standstill when the door 6 of the cooking chamber 2 is opened in order to unload the cooked food products.

In addition to the written disclosure of the invention, reference is explicitly made to the depiction of the commercial cooking device 1 according to the single FIGURE of the drawings.

### LIST OF REFERENCES

1 cooking device
2 cooking chamber
3 motor
4 fan
5 motor brake
6 door
7 housing
8 control means
9 nozzle

What is claimed is:

1. Method of operating a commercial cooking device with the following method steps:
loading food products into a cooking chamber of the cooking device;
starting an associated cooking program including starting to run a motor of a fan for circulating hot air and/or steam within the cooking chamber for the purpose of cooking the food products; and
stopping the motor of the fan at a predetermined period of time before the associated cooking program is finalized.

2. Method according to claim 1, wherein the motor is stopped by actuating a motor brake.

3. Method according to claim 1, wherein the motor is stopped by switching the motor powerless.

4. Method according to claim 1, wherein the motor is restarted, if a door of the cooking chamber is not opened.

5. Commercial cooking device, in particular combi steamer, comprising:
a cooking chamber located in a housing and adapted to receive food products to be cooked according to an associated cooking program;
a door for opening and closing the cooking chamber;
a fan disposed in the cooking chamber;
a motor for driving the fan; and
a controller that controls the cooking program, wherein said controller is adapted to stop the motor to a standstill a predetermined period of time before the associated cooking program is finalized.

6. Cooking device according to claim 5, wherein the motor is equipped with a motor brake.
